(19) United States
(12) Patent Application Publication
(10) Pub. No.: US 2018/0290565 A1
(43) Pub. Date: Oct. 11, 2018

(54) SEAT LOCK DEVICE

(71) Applicant: AISIN SEIKI KABUSHIKI KAISHA, Kariya-shi (JP)

(72) Inventors: Daisuke TONE, Nagakute-shi (JP); Kazuya IWASA, Obu-shi (JP)

(73) Assignee: AISIN SEIKI KABUSHIKI KAISHA, Kariya-shi (JP)

(21) Appl. No.: 15/767,907

(22) PCT Filed: Nov. 8, 2016
(86) PCT No.: PCT/JP2016/083054

§ 371 Date: Apr. 12, 2018

(30) Foreign Application Priority Data
Nov. 9, 2015 (JP) 2015-219591

(51) Int. Cl. B60N 2/22; B60N 2/30

(52) U.S. Cl. CPC B60N 2/2245; B60N 2205/20; B60N 2/3011

(57) ABSTRACT

A seat lock device includes a base, a case, a rotatable hook, a rotatable pawl, and a rotatable cam. The base is arranged in one of a seat and a vehicle body and includes a groove configured to receive a striker arranged on the other one of the seat and the vehicle body. The case is opposed to the base. The case includes a groove configured to receive the striker. The hook cooperates with at least the groove of the case to hold the striker in a locked state. The pawl is engaged with a peripheral surface of the hook to hold the hook in the locked state. The cam presses the hook held in the locked state in a lock direction. A portion of the hook and a portion of the pawl are overlapped with each other in an axial direction of the hook and the pawl.

### TECHNICAL FIELD

The present invention relates to a seat lock device that locks a vehicle seat to a vehicle body.

### BACKGROUND ART

Patent document 1 describes an example of a seat lock device that includes base members, a latch, a pawl, and a cam plate. The base members each include an insertion groove that receives a striker. The latch cooperates with the insertion grooves of the base members to hold the striker. The pawl engages with the latch to hold the latch in a locked state. The cam plate applies pressing force that acts in the lock direction to the latch held in the locked state. The latch, the pawl, and the cam plate are rotationally supported by the base members. Further, the latch includes a restraint groove that engages with the striker in the insertion groove. The restraint groove is opened or closed in the insertion groove in accordance with the rotation position of the latch. The latch is constantly biased in a clockwise direction that is the direction in which the restraint groove opens. The pawl and the cam plate are constantly biased in a counterclockwise direction.

When the striker is forced into the restraint groove that is open in the insertion groove, the latch rotates in the counterclockwise direction against the biasing force that acts in the clockwise direction. The rotation of the latch rotates the pawl in the clockwise direction against the biasing force that acts in the counterclockwise direction. Consequently, a peripheral portion of the pawl engages with a lock receiving portion defined in a peripheral portion of the latch. This restricts the rotation of the latch in the clockwise direction and keeps the constraint groove of the latch closed. Further, when a pressed portion arranged on a side surface of the latch is pressed by a peripheral portion of the cam plate, the latch acts to rotate in the counterclockwise direction (lock direction). The rotation of the latch forces the striker against an inner wall of the insertion groove. This limits clattering of the striker.

### PRIOR ART DOCUMENT

### Patent Document

Patent Document 1: Japanese Patent No. 4383147

### SUMMARY OF THE INVENTION

### Problems that are to be Solved by the Invention

In the seat lock device of patent document 1, engagement of the peripheral portion of the pawl with the lock receiving portion arranged on the peripheral portion of the latch restricts the rotation of the latch in the clockwise direction. This holds the latch in the locked state. Further, twisting of a seat or the like may displace the latch along its rotation axis (for example, toward the opposite side of the cam plate) and disengage the latch from the pawl. Displacement of the latch is restricted by abutment of the latch (for example, portion where the restraint groove is arranged) against the base members.

In order to further stably limit displacement of the latch, the size of a portion of the latch that traverses the insertion groove in the rotation direction when in the locked state needs to be sufficiently larger than the widthwise length of the insertion groove. This is because the latch cannot be sufficiently received in the base members in the locked state when, for example, the portion of the latch including the restraint groove is located in the insertion groove.

However, as the size of the latch in the rotation direction increases, the necessary rotation amount (rotation angle range) of the latch increases. This will further enlarge the seat lock device. There is a demand to reduce the seat lock device in size. The necessity for increasing the size of the latch in the rotation direction is one factor that hinders the reduction of the seat lock device in size.

It is an object of the present invention to provide a seat lock device that is further reduced in size.

A seat lock device that solves the above problem includes a base, a case, a rotatable hook, a rotatable pawl, and a rotatable cam. The base is arranged in one of a seat and a vehicle body and includes a groove configured to receive a striker arranged on the other one of the seat and the vehicle body. The case is opposed to the base. The case includes a groove configured to receive the striker. The hook is arranged between the base and the case. The hook cooperates with at least the groove of the case to hold the striker in a locked state. The pawl is arranged between the base and the case. The pawl is engaged with a peripheral surface of the hook to hold the hook in the locked state. The cam is arranged between the base and the case. The cam presses the hook held in the locked state in a lock direction. A portion of the hook and a portion of the pawl are overlapped with each other in an axial direction of the hook and the pawl.

### BRIEF DESCRIPTION OF THE DRAWINGS

FIG. 1 is a perspective view of a seat showing where one embodiment of a seat lock device is mounted.

FIG. 2 is an exploded perspective view showing the seat lock device of FIG. 1.

FIG. 3 is a front view showing the seat lock device of FIG. 2.

FIG. 4 is a front view showing the seat lock device of FIG. 3 in a state between a locked state and an unlocked state.

FIG. 5 is a front view showing the seat lock device of FIG. 3 in the unlocked state.

FIG. 6 is a front view showing the seat lock device of FIG. 3 in the locked state when a smaller-diameter striker is used.

FIG. 7 is a cross-sectional view taken along line 7-7 in FIG. 3.

FIG. 8 is a front view showing another embodiment of a seat lock device.

FIG. 9 is a cross-sectional view corresponding to FIG. 7 of the seat lock device shown in FIG. 8.

### EMBODIMENTS OP THE INVENTION

One embodiment of a seat lock device applied to a seat arranged in a rear portion of a vehicle will now be described.

Schematic Structure of Seat

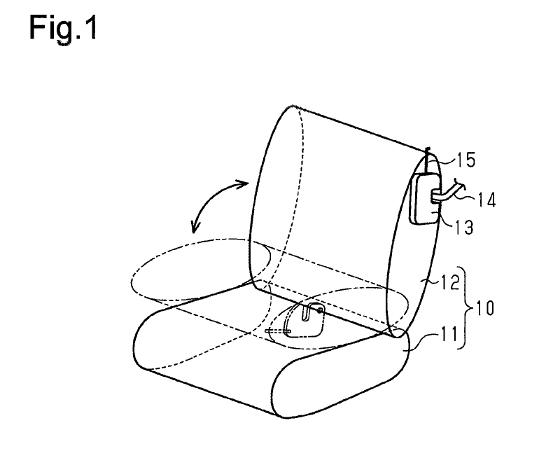

As shown in FIG. 1, a rear seat 10 includes a seat cushion 11 on which a vehicle occupant is seated and a seat back 12 against which a back of the vehicle occupant is leaned. The seat back 12 is arranged to be rotatable relative to the seat cushion 11 about a lower end portion of the seat back 12. The seat back 12 moves between an upright position shown by the solid lines in FIG. 1 and a forward-inclined position shown by the double-dashed lines in FIG. 1.

A seat lock device 13 is arranged on an upper side surface of the seat back 12. When the seat back 12 is located at the upright position, the seat lock device 13 is engaged with a U-shaped striker 14 arranged on a vehicle body to hold the seat back 12 in place. That is, the seat 10 is locked to the vehicle body. A wire 15 coupled to the seat lock device 13 is pulled to disengage the seat lock device 13 from the striker 14. This allows the seat back 12 to rotate from the upright position to the forward-inclined position. The wire 15 functions as an operation member.

Seat Lock Device

The structure of the seat lock device will now be described in detail.

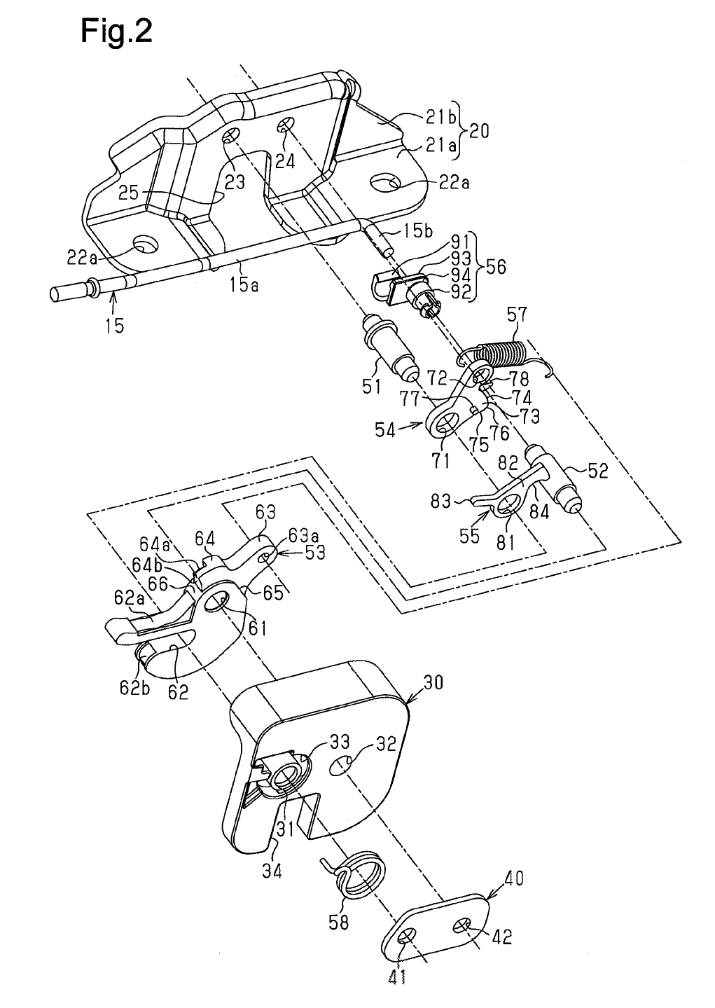

As shown in FIG. 2, the seat lock device 13 includes a base bracket 20 functioning as a base, a case 30, and a sub-base bracket 40.

The base bracket 20 is formed from a metal material and has an L-shaped cross section. The base bracket 20 includes a rectangular coupling plate 21a fixed to a seat frame (not shown) (more specifically, seat bracket) and a rectangular support plate 21b that is orthogonal to the coupling plate 21a. Bolt holes 22a extend through the coupling plate 21a at two ends in a longitudinal direction, respectively. Bolts (not shown) used to fix the base bracket 20 to the seat bracket are inserted through the bolt holes 22a and 22a, respectively. The support plate 21b includes two insertion holes 23 and 24. The insertion holes 23 and 24 are arranged next to each other in the longitudinal direction of the support plate 21b. Further, the base bracket 20 includes a groove 25 into which the striker 14 is inserted. The groove 25 is formed by notching the support plate 21b from the vicinity of the middle of the one of the two long edges of the coupling plate 21a at the opposite side of the support plate 21b to an intermediate portion of the support plate 21b. The portion of the support plate 21b including the groove 25 has the form of a trapezoid that increases in width toward the coupling plate 21a (lower side in FIG. 2).

A side surface of the case 30 is opposed to the support plate 21b of the base bracket 20. The case 30 is formed from a synthetic resin material and is box-shaped. The case 30 opens toward the support plate 21b. The case 30 (specifically, flat end wall of case 30) includes a tubular boss 31 and an insertion hole 32. The boss 31 is located on the same axis as the insertion hole 23 of the base bracket 20. The insertion hole 32 is located on the same axis as the insertion hole 24 of the base bracket 20. Further, the case 30 includes an annular spring insertion hole 33 located around the boss 31 and a groove 34 into which the striker 14 is inserted. The groove 34 is formed by notching a lower portion of the case 30 shown in FIG. 2. When the case 30 is viewed in the axial direction of the boss 31, the groove 34 is overlapped with the groove 25 of the base bracket 20.

The sub-base bracket 40 is formed from a metal material and has the form of a rectangular plate. The sub-base bracket 40 includes two insertion holes 41 and 42. The insertion holes 41 and 42 are arranged next to each other in the longitudinal direction of the sub-base bracket 40. The insertion hole 41 is located on the same axis as the boss 31 of the case 30 and the insertion hole 23 of the base bracket 20. The insertion hole 42 is located on the same axis as the insertion hole 32 of the case 30 and the insertion hole 24 of the base bracket 20.

A pawl pin 51, a hook pin 52, a hook 53, a pawl 54, a cam 55, a snap 56, a pawl spring 57, and a cam spring 58, which are other components of the seat lock device 13, are arranged between the base bracket 20 and the case 30.

Pawl Pin/Hook Pin

A first end of the pawl pin 51 is inserted through the insertion hole 23 of the base bracket 20. A second end of the pawl pin 51 is inserted through the boss 31 of the case 30 and the insertion hole 41 of the sub-base bracket 40. Further, a first end of the hook pin 52 is inserted through the insertion hole 24 of the base bracket 20, and a second end of the hook pin 52 is inserted through the insertion hole 32 of the case 30 and the insertion hole 42 of the sub-base bracket 40. The pawl pin 51 is coupled to the base bracket 20. the case 30, and the sub-base bracket 40 by swaging the two ends of the pawl pin 51. The hook pin 52 is coupled to the base bracket 20, the case 30, and the sub-base bracket 40 by swaging the two ends of the hook pin 52. The sub-base bracket 40 is kept in contact with the end wall of the case 30.

Hook

The hook 53 is arranged to be rotatable relative to the hook pin 52. The hook 53 is formed from a metal material. The hook 53 includes a bearing hole 61 through which the hook pin 52 is inserted and a restraint groove 62 through which the striker 14 is inserted. The restraint groove 62 is a groove between a first projection 62a and a second projection 62b extending in a direction that is orthogonal to the axis of the bearing hole 61 (leftward in FIG. 2). The first projection 62a starts projecting from a position that is closer to the bearing hole 61 than the second projection 62b. In FIG. 2, the first projection 62a is located above the second projection 62b. Further, the first projection 62a is longer than the second projection 62b.

The hook 53 includes a hooking portion 63 and a pressed portion 64. The hooking portion 63 projects from a part of a peripheral portion of the hook 53 at the opposite side of the restraint groove 62 with respect to the bearing hole 61. The hooking portion 63 extends away from the bearing hole 61 (diagonally upper right side in FIG. 2). The hooking portion 63 includes a hooking hole 63a. The pressed portion 64 projects from the peripheral portion of the hook 53 between the first projection 62a and the hooking portion 63. The pressed portion 54 extends away from the bearing hole 61 (upward in FIG. 2). A step 64a is arranged on a side surface of the pressed portion 64 at the side opposite to the case 30. The step 64a is arranged at a corner formed by a distal end surface of the pressed portion 64 and a side surface 64b at the side opposite to the hooking portion 63 in the rotation direction of the hook 53.

The hook 53 is covered by a buffer 65 and partially exposed. The hooking portion 63 and the pressed portion 64 are exposed to the outside. A side surface of the hook 53 and an inner surface of the restraint groove 62 are covered by the buffer 65. The buffer 65 includes a portion functioning as an abutted portion 66 that couples together the parts (parts around bearing hole 61) covering two side surfaces of the hook 53 and located at opposite sides in the axial direction near a basal end of the pressed portion 64. The abutted portion 66 has an arcuate surface that is concentric with the bearing hole 61 as viewed in the axial direction of the bearing hole 61. The buffer 65 is formed from a synthetic resin material.

Pawl/Cam

The pawl 54 and the cam 55 are arranged to be rotatable relative to the pawl pin 51. Further, the pawl 54 and the cam 55 are held in a state in which movement is restricted in the axial direction of the pawl pin 51. The pawl 54 is located between the cam 55 and the base bracket 20. The pawl 54 and the cam 55 are arranged at a location that substantially corresponds to the hook 53 in the axial direction of the pawl pin 51.

The pawl 54 is formed from a metal material and is plate-shaped. The pawl 54 includes a bearing hole 71 through which the pawl pin 51 is inserted and a coupling hole 72 through which the snap 56 is partially inserted. Further, a rounded triangular engagement projection 73 is arranged at the periphery of the pawl 54 between the part where the bearing hole 71 is formed and the part where the coupling hole 72 is formed. The engagement projection 73 projects toward the hook 53. A rotation restriction surface 74 is defined by a portion of the outer edge of the engagement projection 73 at a side corresponding to the coupling hole 72. The rotation restriction surface 74 is an arcuate surface about the axis of the bearing hole 71. A curved guide surface 75 is defined by a portion of the outer edge of the engagement projection 73 at a side corresponding to the bearing hole 71. An abutting portion 76 having an arcuate surface is arranged at a portion corresponding to the top of the engagement projection 73 where the rotation restriction surface 74 intersects the guide surface 75. In addition, a cylindrical projection 77 projects from a side surface of the pawl 54 opposing the cam 55. A restriction projection 78 projects from a side surface of the pawl 54 at the side opposite to the cam 55. The restriction projection 78 is arranged near the rotation restriction surface 74. Further, the restriction projection 78 projects from the rotation restriction surface 74 toward the hook 53.

The cam 55 is formed from a metal material and is plate-shaped. The cam 55 includes a bearing hole 81 through which the pawl pin 51 is inserted. Further, a pressing projection 82 and a hooking projection 83 are arranged on the peripheral portion of the cam 55. The pressing projection 82 and the hooking projection 83 are located at opposite sides of the bearing hole 81 as viewed in the axial direction of the bearing hole 81. The pressing projection 82 extends toward the hook 53. The hooking projection 83 extends toward the opposite side of the hook 53. The pressing projection 82 has a distal end surface that is gradually curved. Further, an engagement surface 84 having a recessed curved surface is defined by a side edge of the pressing projection 82 as viewed in the axial direction of the bearing hole 81. The distal end surface of the pressing projection 82 and the engagement surface 84 are smooth curved surfaces that are continuous with each other.

Snap

The snap 56 is formed from a synthetic resin material. The snap 56 includes a support 91 having a U-shaped cross section, a tubular bushing 92, and a rectangular coupling portion 93. The support 91 and the bushing 92 are coupled to each other by the coupling portion 93. The center axis of the support 31 and the center axis of the bushing 92 are orthogonal to each other. The support 91 is arranged near a first end of the coupling portion 93, and the bushing 92 is arranged near a second end of the coupling portion 93. The bushing 92 includes a distal portion that is fitted into the coupling hole 72 of the pawl 54 from the side opposite to the cam 55. An annular spring hooking groove 94 is arranged at a boundary of the coupling portion 93 and the bushing 92.

The wire 15 is L-shaped and includes a long axis portion 15a and a short axis portion 15b. The short axis portion 15b is extended through the coupling portion 93 and inserted through the bushing 92. The part of the long axis portion 15a coupled to the short axis portion 15b is fitted into and supported by the support 91. The long axis portion 15a is guided to the outside through a gap between the base bracket 20 and the case 30. The long axis portion 15a includes an outer end that may be coupled to a knob (not shown) arranged on the seat back 12.

Pawl Spring/Cam Spring

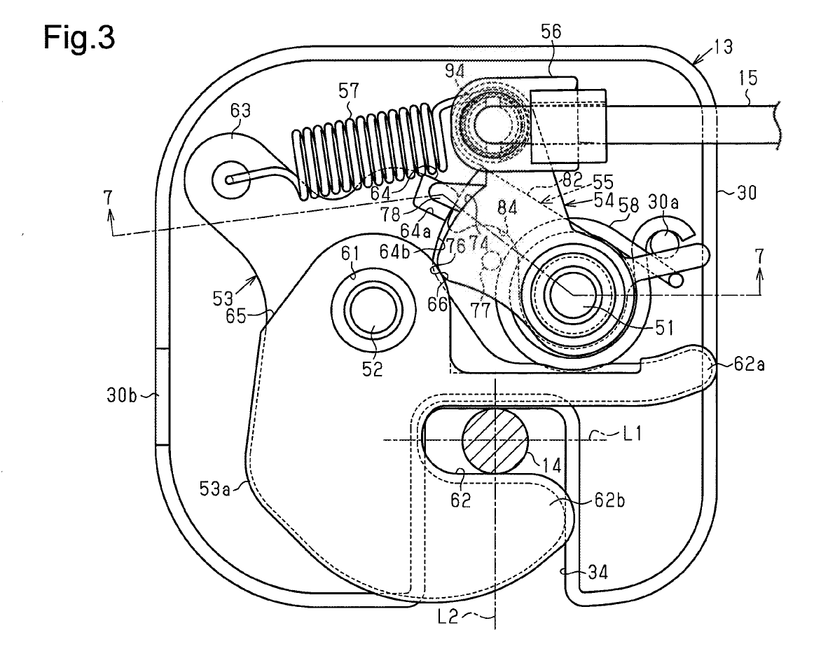

As shown in FIG. 3, the pawl spring 57 is a compression coil spring. A first end of the pawl spring 57 is hooked to the hooking hole 63a of the hook 53. A second end of the pawl spring 57 is hooked to the spring hooking groove 94 of the snap 56. Thus, the hook 53 is constantly biased in the clockwise direction in FIG. 3 by the elastic force of the pawl spring 57. The pawl 54 is constantly biased in the counterclockwise direction in FIG. 3 by the elastic force of the pawl spring 57.

The cam spring 58 is a torsion coil spring. A first end of the cam spring 58 is hooked to a spring hooking projection 30a that projects from an inner wall of the case 30. A second end of the cam spring 58 is hooked to the lower portion of the hooking projection 83 of the cam 55 in FIG. 3 (portion of hook 53 at side opposing first projection 62a). Thus, the cam 55 is constantly biased in the counterclockwise direction in FIG. 3 by the elastic force of the cam spring 58.

Locked State

In the locked state in which the seat lock device 13 restrains the striker 14, each of the components of the seat lock device 13 is maintained in the state described below.

As shown in FIG. 3, the abutting portion 76 of the pawl 54 is abut against the abutted portion 66 of the buffer 65. Elastic force of the pawl spring 57 keeps the abutting portion 76 forced against the abutted portion 66. Further, a gap extends between the rotation restriction surface 74 of the pawl 54 and the pressed portion 64 of the hook 53 (specifically, side surface 64b of the pressed portion 64). In addition, the restriction projection 78 of the pawl 54 and the step 64a of the hook 53 are overlapped with each other as viewed in the axial direction of the pawl pin 51. The step 64a of the hook 53 and the restriction projection 78 of the pawl 54 are engageable with each other in the axial direction of the hook pin 52.

The distal end surface of the pressing projection 82 of the cam 55 is abut against the side surface 64b of the pressed portion 64 of the hook 53, specifically, portion of the side surface 64b that corresponds to the step 64a. Rotation of the hook 53 in the clockwise direction produced by elastic force of the pawl spring 57 is restricted when the side surface 64b of the pressed portion 64 of the hook 53 is abut against the distal end surface of the pressing projection 82 of the cam 55. As viewed in the axial direction of the pawl pin 51, the distance from the center of the pawl pin 51 to the distal end surface of the pressing projection 82 of the cam 55 is slightly longer than the distance from the center of the pawl pin 51 to the rotation restriction surface 74. Thus, the above gap extends between the rotation restriction surface 74 of the pawl 54 and the pressed portion 64 of the hook 53.

The position of the hook 53 will now be described. The hook 53 is held at a position where the center line L1 of the restraint groove 62 intersects (is orthogonal to) the center line L2 of the groove 34 of the case 30 as viewed in the axial direction of the hook pin 52. The first projection 62a and the second projection 62b intersect the center line L2 of the groove 34 of the case 30. Further, although not shown in FIG. 3, the restraint groove 62, the first projection 62a, and the second projection 62b intersect the center axis of the groove 25 of the base bracket 20.

The first projection 62a is located slightly upward from the groove 34 of the case 30 as viewed in the axial direction of the hook pin 52. Further, the second projection 62b traverses the groove 34 of the case 30 as viewed in the axial direction of the hook pin 52. A distal end of the second projection 62b (right end of second projection 62b shown by dotted line in FIG. 3) coincides with a peripheral wall of the case 30, which includes the groove 34, in the direction that is orthogonal to the center line L2 of the groove 34 (lateral direction in FIG. 3) as viewed in the axial direction of the hook pin 52. A portion of the buffer 65 that covers the second projection 62b is located outward from the groove 34 by an amount corresponding to the thickness of that portion.

The striker 14 is held between the second projection 62b of the hook 53 and a closed end of the groove 34 in the case 30 (upper portion of groove 34 in FIG. 3). The hook 53 acts to rotate in the counterclockwise direction when the side surface 64b of the pressed portion 64 is pressed by the cam 55. The rotation of the hook 53 in the counterclockwise direction is restricted when the second projection 62b forces the striker 14 against the closed end of the groove 34 of the case 30.

Unlocking Operation of Seat Lock Device

The operation for shifting the seat lock device 13 from the locked state to the unlocked state will now be described.

As shown in FIG. 3, when the seat lock device 13 is maintained in a locked state, the distal end surface of the pressing projection 82 of the cam 55 is abut against the side surface 64b of the pressed portion 54 of the hook 53. Further, the abutting portion 76 of the pawl 54 is abut against the abutted portion 66 of the buffer 65.

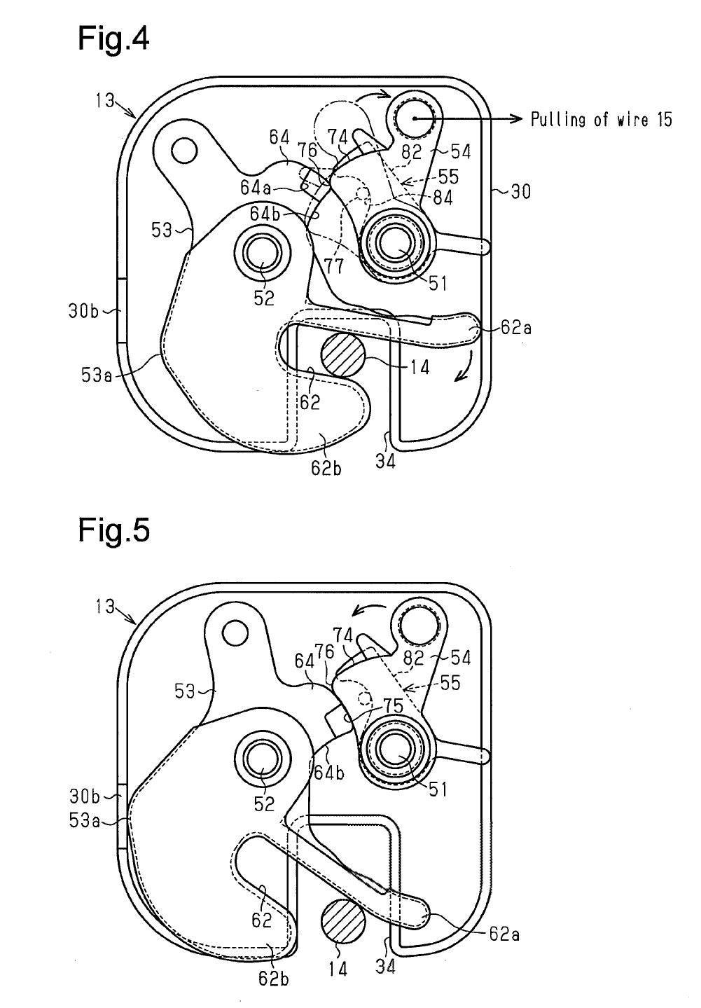

As shown in FIG. 4, when shifting the seat lock device 13 from the locked state to the unlocked state, the wire 15 is pulled. The pulling of the wire 15 rotates the pawl 54 against the elastic force of the pawl spring 57 in the clockwise direction. Further, the elastic force of the pawl spring 57 biases the hook 53 in the clockwise direction. Thus, when the pawl 54 rotates in the clockwise direction, the abutting portion 76 of the pawl 54 slides on the pressed portion 64 of the hook 53 from the basal end toward the distal end of the pressed portion 64.

In the rotation direction of the pawl 54, after the projection 77 of the pawl 54 abuts against the engagement surface 84 of the cam 55, the cam 55 rotates in the clockwise direction integrally with the pawl 54 against the elastic force of the cam spring 58. Consequently, the cam 55 is disengaged from the pressed portion 64 (side surface 64b) of the hook 53. Then, the abutting portion 76 of the pawl 54 reaches a distal end corner of the pressed portion 64 of the hook 53 (portion corresponding to step 64a).

When the pawl 54 further rotates in the clockwise direction and the abutting portion 76 of the pawl 54 moves beyond the distal end corner of the pressed portion 64 of the hook 53, this releases the side surface 64b of the pressed portion 64 of the hook 53 from the state engaged with the pawl 54. Thus, the elastic force of the pawl spring 57 rotates the hook 53 immediately in the clockwise direction.

As shown in FIG. 5, as the hook 53 rotates in the clockwise direction, the first projection 62a presses the striker 14 to force the striker 14 out of the groove 34 of the case 30. Further rotation of the hook 53 in the clockwise direction slides the distal end surface of the pressed portion 64 on the guide surface 75 from a distal end toward a basal end of the guide surface 75. Consequently, a restriction portion 53a arranged at the outer edge of the hook 53 abuts against a stopper 30b arranged in the peripheral wall of the case 30. This restricts the rotation of the hook 53 in the clockwise direction. The restriction portion 53a of the hook 53 is defined by a portion of the outer edge of the hook 53 at the side opposite to the restraint groove 62 in the opening direction of the restraint groove 62 (left portion in outer edge of hook 53 as viewed in FIG. 5).

As viewed in the axial direction of the hook pin 52, by keeping the restriction portion 53a of the hook 53 in a state abut against the stopper 30b of the case 30, the restraint groove 62 remains open in the groove 34 of the case 30, that is, is maintained in the unlocked state in which the opening of the restraint groove 62 is overlapped with the groove 34 of the case 30. In the unlocked state, the first projection 62a of the hook 53 is arranged to diagonally traverse the groove 34 of the case 30. The distal end of the second projection 62b of the hook 53 is located outside the groove 34 of the case 30.

When the restriction portion 53a of the hook 53 is abut against the stopper 30b of the case 30, the striker 14 is located completely outside the restraint groove 62. By keeping the restriction portion 53a of the hook 53 in the state abut against the stopper 30b of the case 30, the seat lock device 13 is maintained in the unlocked state. The pawl 54 acts to rotate in the counterclockwise direction because of the elastic force of the pawl spring 57. The rotation of the pawl 54 is restricted by the abutment of the guide surface 75 against the distal end surface of the pressed portion 64. Thus, even when the pulled wire 15 is released, the seat lock device 13 is maintained in the unlocked state.

Subsequently, when the seat back 12 is rotated from the upright position toward the forward-inclined position, the seat lock device 13 moves away from the striker 14. Thus, the striker 14 is smoothly separated from the groove 34.

Locking Operation of Seat Lock device

The operation for changing the seat lock device 13 from the unlocked state to the locked state will now be described.

As shown in FIG. 5, when the seat lock device 13 is maintained in an unlocked state, the opening of the restraint groove 62 of the hook 53 is overlapped with the opening of the groove 34 of the case 30. Further, the first projection 62a of the hook 53 diagonally intersects the groove 34 of the case 30 (extends from upper left side toward lower right side in FIG. 5). Thus, when the seat back 12 is rotated from the upright position toward the forward-inclined position, the striker 14 enters the groove 34 of the case 30 and consequently abuts against the first projection 62a of the hook 53. The striker 14 moves toward the closed end of the groove 34 of the case 30 and presses the first projection 62a of the hook 53. This rotates the hook 53 in the counterclockwise direction against the elastic force of the pawl spring 57. As the hook 53 rotates in the counterclockwise direction, the first projection 62a moves toward the closed end of the groove 34 in the case 30 as the striker 14 moves toward the closed end of the groove 34 in the case 30. That is, the striker 14 pushes away the first projection 62a and moves toward the closed end of the groove 34. In addition, rotation of the hook 53 in the counterclockwise direction moves the pressed portion 64 in the counterclockwise direction. The distal end surface of the pressed portion 64 slides on the guide surface 75 of the pawl 54 from the basal end toward the distal end of the guide surface 75.

As shown in FIG. 4, further rotation of the hook 53 in the counterclockwise direction moves the distal end corner of the pressed portion 64 of the hook 53 (portion corresponding to step 64a) to the abutting portion 76 of the pawl 54. As the hook 53 further rotates in the counterclockwise direction and the distal end corner of the pressed portion 64 of the hook 53 moves beyond the abutting portion 76 of the pawl 54, this releases the guide surface 75 of the pawl 54 from the state engaged with the distal end surface of the pressed portion 64 of the hook 53. That is, the restriction on the rotation of the pawl 54 in the counterclockwise direction is cancelled.

As shown in FIG. 3, when the restriction on the rotation of the pawl 54 in the counterclockwise direction is cancelled, the elastic force of the pawl spring 57 rotates the pawl 54 immediately in the counterclockwise direction. The rotation restriction surface 74 of the pawl 54 slides on the side surface 64b of the pressed portion 64 of the hook 53 from the distal end toward the basal end of the side surface 64b. Consequently, when the abutting portion 76 of the pawl 54 abuts against the abutted portion 66 of the buffer 65, the rotation of the pawl 54 in the counterclockwise direction is restricted. After the striker 14 abuts against the closed end of the groove 34, the first projection 62a of the hook 53 is no longer pressed by the striker 14.

Further, as the pawl 54 rotates in the counterclockwise direction, the elastic force of the cam spring 58 rotates the cans 55 in the counterclockwise direction. The distal end surface of the pressing projection 82 of the cam 55 slides on the side surface 64b of the pressed portion 64 of the hook 53 from the distal end to the basal end of the side surface 64b slightly delayed from the pawl 54. When the pressing projection 82 of the cam 55 presses the pressed portion 64 of the hook 53, the hook 53 slightly rotates in the counterclockwise direction against the elastic force of the pawl spring 57. The slight rotation of the hook 53 causes the second projection 62b to further press the striker 14 toward the closed end of the groove 34 of the case 30. Thus, the striker 14 is held between the closed end of the groove 34 and the second projection 62b of the hook 53 in a locked state without clattering.

Operation of Abutted Portion of Cover Member

The outer diameter of the striker 14 differs in accordance with the vehicle type.

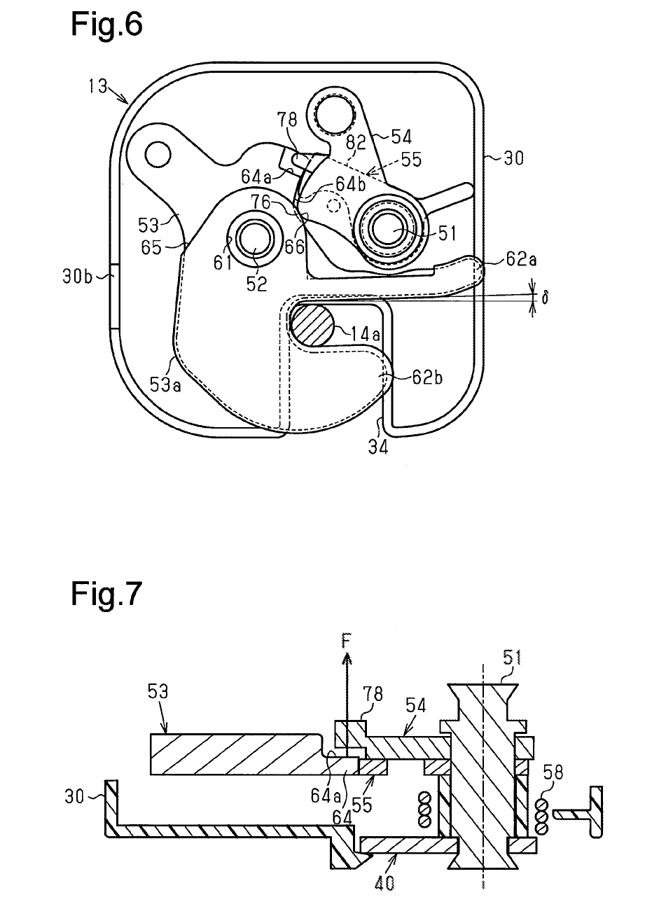

FIG. 6 shows an example of a case employing a striker 14a that has a smaller diameter than the striker 14. In this case, when the seat lock device 13 shifts from the unlocked state to the locked state, the hook 53 is excessively rotated in the counterclockwise direction in accordance with the difference between the striker 14 and the striker 14a, which has a smaller diameter than the striker 14. More specifically, the hook 53 is further rotated in the counterclockwise direction from the position shown in FIG. 3 by a rotation amount (rotation angle) δ. This holds the smaller-diameter striker 14a between the second projection 62b of the hook 53 and the closed end of the groove 34 of the case 30 without clattering. As compared with the locked state shown in FIG. 3, the distal end surface of the pressing projection 82 of the cam 55 is located closer to the basal end of the side surface 64b of the pressed portion 64 of the hook 53.

The abutted portion 66 has an arcuate surface that is concentric with the bearing hole 61 as viewed in the axial direction of the hook pin 52. Thus, even if the different (smaller) outer diameter of the striker 14 results in a different rotation amount of the hook 53 when the seat lock device 13 is shifted from the locked state to the unlocked state, the rotation position of the pawl 54 remains unchanged. Further, the buffer 65 including the abutted portion 66 is formed from a synthetic resin material. Thus, when the seat lock device 13 shifts from the unlocked state to the locked state, abutment of the restriction projection 78 of the metal pawl 54 against the synthetic resin abutted portion 66 produces a further luxurious striking sound.

Operation of Step of Hook and Restriction Projection of Pawl

The operation of the step 64a of the hook 53 and the restriction projection 78 of the pawl 54 will now be described. When the seat lock device 13 is maintained in the locked state shown in FIG. 3, for example, the seat 10 may fee twisted due to one reason or another.

As shown in FIG. 7, in this case, when the seat 10 is twisted or the like, a force F in the vertical direction may act on the hook 53. The force F is a force that moves the hook 53 away from the case 30 (end wall). Thus, when the hook 53 receives the force F, the hook 53 acts to incline away from the case 30. However, the step 64a of the hook 53 and the restriction projection 78 of the pawl 54 are opposed to each other in the axial direction of the pawl pin 51. Thus, the abutment of the step 64a of the hook 53 against the restriction projection 78 of the pawl 54 restricts the hook 53 from inclining away from the case 30. This stably keeps the side surface 64b of the pressed portion 64 of the hook 53 engaged with the distal end surface of the pressing projection 82 of the cam 55 and stably keeps the abutted portion 66 of the buffer 65 engaged with the abutting portion 76 of the pawl 54.

Further, the step 64a is arranged at a distal part of the pressed portion 64 of the hook 53 that is engaged with the pawl 54 and the cam 55. The distal part of the pressed portion 64 is the portion that is directly engaged with the pawl 54 and the cam 55 and is the portion that is most likely to be disengaged from the pawl 54 and the cars 55 when the force F in the axial direction of the hook pin 52 acts on the hook 53. Thus, it is preferred that the step 64a be arranged at the distal part of the pressed portion 64. When the step 64a is received by the restriction projection 78 of the pawl 54, the inclination of the hook 53 is limited in a further preferred manner.

Force that moves the hook 53 toward the end wall of the case 30 (force in direction opposite to force F) may act on the hook 53. In this case, the hook 53 may be received by, for example, ribs (not shown) arranged on the end wall of the case 30.

Length of Second Projection

In addition, when the force F that moves the hook 53 away from the case 30 acts on the hook 53, the structure of the restriction projection 78 of the pawl 54 engaged with the step 64a of the hook 53 allows for reduction in the size of the hook 53 in the rotation direction, more specifically, the length of the second projection 62b.

As a comparative example, for instance, the step 64a and the restriction projection 78 may be omitted. In this case, the hook 53 is not overlapped with the pawl 54 in the axial direction of the pawl pin 51. Thus, twisting of the seat 10 or the like may displace the hook 53 sideward in the axial direction of the hock pin 52 and release the hook 53 from the state engaged with the pawl 54. In order to keep the hook 53 engaged with the pawl 54, for example, the following structure may be employed.

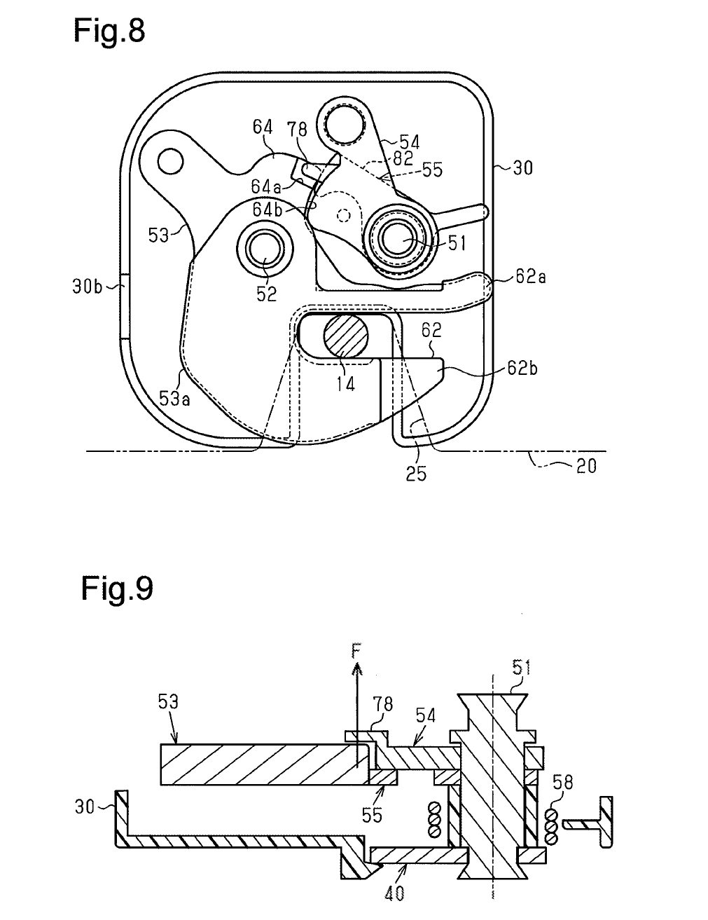

As shown in FIG. 8, the size of the hook 53 in the rotation direction, more specifically, the length of the second projection 62b, is set to be greater. The length of the second projection 62b is set such that the hook 53 including the second projection 62b traverses the groove 25 of the base bracket 20 when the seat lock device 13 is maintained in a locked state. Thus, when the hook 53 acts to incline away from the case 30 in the axial direction of the hook pin 52, the distal end of the second projection 62b abuts against the base bracket 20 (specifically, portion near groove 25) from the inner side. This limits sideward inclination of the hook 53 in the axial direction of the hook pin 52.

However, in this case, as the length of the second projection 62b increases, the rotation amount of the hook 53 increases when shifting from the locked state to the unlocked state. This may enlarge the seat lock device 13 including the case 30.

In the seat lock device 13 of the present example shown in FIG. 3 and the like, when the hook 53 acts to incline in the axial direction of the hook pin 52, the hook 53 is received by the restriction projection 78 of the pawl 54 through the step 64a. Since the second projection 62b does not need to be engaged with the base bracket 20, the length of the second projection 62b of the hook 53 can be set to be shorter. When the seat lock device 13 is maintained in the locked state, the second projection 62b only needs to be long enough to restrain the striker 14 in the groove 34 of the case 30, that is, long enough to close the groove 34 of the case 30 as viewed in the axial direction of the hook pin 52. The rotation amount of the hook 53 is decreased by an amount corresponding to the reduced length of the second projection 62b when the seat lock device 13 is shifted from the locked state to the unlocked state. Consequently, the entire seat lock device 13 including the case 30 can be further reduced in size.

However, as long as the size of the seat lock device 13 is not a problem, the length of the second projection 62b may be increased as shown in FIG. 8 even if the hook 53 includes the step 64a. This further ensures that the inclination of the hook 53 in the axial direction of the hook pin 53 is restricted by the abutment of the step 64a against the restriction projection 78 of the pawl 54 and the abutment of the distal end of the second projection 62b against the base bracket 20. In addition, the inclination of the hook 53 is received at two positions, namely, the step 64a and the distal portion of the second projection 62b. Thus, the thickness of the hook 53 can further be reduced.

Size of Cam

In addition, when shifting the seat look device 13 from an unlocked state to a locked state, in order to further rotate the hook 53 in the counterclockwise direction with the pressed portion 64 of the hook 53 engaged with the pawl 54, the pressing projection 82 of the cam 55 presses the side surface 64b of the pressed portion 64 of the hook 53. This presses the hook 53 to be rotated in the counterclockwise direction without increasing the length of the cam 55.

For example, in order to rotate the hook 53 in the direction that forces the striker 14 against the closed end of the groove 34 of the case 30, a pressed portion such as a projection may be arranged on the side surface of the hook 53 in the axial direction of the hook pin 52 so that the pressed portion is pressed by a cam. However, when this structure is employed, the cam needs to be lengthened to the position of the projection on the side surface of the hook 53. This lengthens the cam 55 and increases the rotation amount of the cam 55. Thus, the size of the seat lock device 13 (in particular, size in vertical direction in FIG. 3 and the like) may be increased.

In this regard, when the cam 55 of the present example is employed, the cam 55 does not need to be lengthened to a position overlapping the hook 53 in the axial direction of the hook pin 52. This further reduces the size of the cam 55 and consequently reduces the size of the seat lock device 13.

### Advantages of Embodiment

Accordingly, the present embodiment has the advantages described below.

(1) For example, twisting or the like of the seat 10 such as when a vehicle collides may result in sideward movement (inclination) of the hook 53 in the axial direction of the hook pin 52. The sideward movement of the hook 53 is restricted by the engagement of the step 64a, which is a portion of the hook 53, with the restriction projection 78, which is a portion of the pawl 54. Thus, the second projection 62b only needs to be long enough to close the restraint groove 62 in the groove 34 of the case 30 during the locked state. Thus, as compared with when the distal end of the second projection 62b is engaged with the base bracket 20 to restrict sideward displacement of the hook 53, a short length may be set for the second projection 62b. The decrease in the length of the second projection 62b decreases the rotation amount of the hook 53 when shifting from the locked state to the unlocked state. Consequently, the size of the seat lock device 13 (in particular, size of seat lock device 13 in sideward direction in FIG. 3 and the like) is further reduced.

(2) In addition, sideward displacement of the hook 53 is limited by the engagement of the step 64a of the hook 53 with the restriction projection 78 of the pawl 54. This improves the degree of design freedom for the base bracket 20. For example, in a structure that does not include the step 64a of the hook 53 and the restriction projection 78 of the pawl 54, the distal end of the second projection 62b may be engaged with a portion near the groove 25 of the base bracket 20 to limit sideward displacement of the hook 53. In this case, the second projection 62b needs to be long so that the second projection 62b traverses the groove 25 of the base bracket 20 over a great amount at least in the locked state. This reduces the degree of design freedom of the base bracket 20. In the present example, the second projection 62b does not necessarily have to be engaged with the base bracket 20. This improves the degree of design freedom of the base bracket 20, for example, further reduces the length of the second projection 62b.

(3) The step 64a is arranged in the distal part of the pressed portion 64, which is the portion of the hook 53 that engages with the pawl 54 and the cam 55. The distal part of the pressed portion 64 is received by the restriction projection 78 of the pawl 54 through the step 64a to limit the inclination of the hook 53 in a further preferred manner. In addition, the distal part of the pressed portion 64 (distal part of pressed portion 64 that is farthest from rotation axis of hook 53 in radial direction) is a portion of the hook 53 that is most likely to be disengaged from the pawl 54 and the cam 55. When the pressed portion 64 is received by the restriction projection 78 of the pawl 54, the holding strength for countering sideward displacement (inclination) of the hook 53 is ensured. This further reduces the hook 53 in thickness and weight.

(4) Under a normal condition in which the force F in the vertical direction does not act on the hook 53, when the seat lock device 13 is maintained in a locked state, the restriction projection 78 of the pawl 54 remains in the step 64a of the hook 53. That is, the restriction projection 78 of the pawl 54 is located within and overlapped with the step 64a of the hook 53. The seat lock device 13 may be further reduced in size in the axial direction of the hook pin 52 by an amount corresponding to the amount of the restriction projection 78 in the step 64a.

When shifting the seat lock device 13 from the unlocked state to the locked state, the pressing projection 82 of the cam 55 presses the side surface 64b of the pressed portion 64 of the hook 53. This presses the hook 53 in the counterclockwise direction without increasing the length of the cam 55 in contrast with when a projection is arranged on the side surface of the hook 53 and the projection is pressed by the cam 55. In addition, the length of the cam 55 can be decreased. This allows the rotation amount of the cam 55 and the width of the cam 55 in the rotation direction to be further decreased. Thus, the seat lock device 13 may be further reduced in size (in particular, size of seat lock device 13 in vertical direction in FIG. 3 and the like).

(6) Additionally, the support strength in the rotation direction of the hook 53 (entering direction of striker 14) and the support strength in the axial direction of the hook pin 52 are obtained just by the engagement of the hook 53 and the pawl 54.

(7) The abutted portion 66 of the buffer 65 has an arcuate surface that is concentric with the bearing hole 61 as viewed in the axial direction of the hook pin 52. Thus, for example, even if the outer diameter of the striker 14 differs in accordance with the vehicle type and results in a different rotation amount of the hook 53 when shifting from the locked state to the unlocked state, the rotation position of the pawl 54 remains unchanged.

(8) In addition, the buffer 65 including the abutted portion 66 is formed from a synthetic resin material. Thus, when shifting from the unlocked state to the locked state, abutment of the restriction projection 78 of the metal pawl 54 against the synthetic resin abutted portion 66 produces a further luxurious striking sound.

(9) The first end of the pawl spring 57 is hooked to the hooking hole 63a of the hook 53, and the second end of the pawl spring 57 is hooked to the spring hooking groove 94 of the snap 56. Thus, the pawl 54 does not need an additional portion to which the second end of the pawl spring 57 is hooked. Elastic force of the pawl spring 57 acts on the portion of the pawl 54 where the coupling hole 72 is arranged. To rotate and bias the pawl 54, it is preferred that elastic force of the pawl spring 57 act on the end of the pawl 54 at the side opposite to the bearing hole 71. That is, the portion of the pawl 54 including the coupling hole 72 is the most desirable point for the elastic force of the pawl spring 57 to act. Thus, elastic force of the pawl spring 57 acts on the pawl 54 in a further preferred manner. The pawl 54 is rotated and biased by the intended elastic force. Although the snap 56 is formed from a synthetic resin, the short axis portion 15b of the wire 15 is inserted into the bushing 92 of the snap 56. This ensures enough strength that withstands the elastic force of the pawl spring 57 even if the pawl spring 57 is hooked to the bushing 92 of the snap 56.

### Other Embodiments

The present embodiment may be modified as described below.

In the present example, the step 64a is arranged on the pressed portion 64 of the hook 53. However, the position of the step 64a of the hook 53 may be changed. For example, the step 64a may be arranged at any position in the range of the outer edge of the hook 53 from the pressed portion 64 to the first projection 62a as viewed in the axial direction of the hook pin 52. The step 64a only needs to be engageable with a portion of the pawl 54 (for example, restriction projection 78) as viewed in the axial direction of the hook pin 52.

In the present example, in order to restrict sideward movement of the hook 53, the step 64a of the hook 53 is engaged with the restriction projection 78 of the pawl 54. However, the step 64a of the hook 53 may be omitted. In this case, as shown in FIG. 9, when the seat lock device 13 is maintained in a locked state, the hook 53 and the pawl 54 are arranged so that the side surface of the hook 53 at the side opposite to the case 30 and the restriction projection 78 of the pawl 54 are opposed to each other in the axial direction of the pawl pin 51. This engages the restriction projection 78 of the pawl 54 with the side surface of the hook 53 at the side opposite to the case 30 when the force F acts on the hook 53 and moves the hook 53 away from the case 30. The side surface of the hook 53 at the side opposite to the case 30 abuts against the restriction projection 78 of the pawl 54 in the axial direction of the pawl pin 51. This restricts the hook 53 from moving away from the case 30.

In the present example, the striker 14 is arranged on the vehicle body, and the seat lock device 13 is arranged on the seat back 12. Instead, the seat lock device 13 may be arranged on the vehicle body, and the striker 14 may be arranged on the seat back 12. Alternatively, the seat lock device 13 may be arranged on the seat cushion 11, and the striker 14 may be arranged on the floor surface of the vehicle body. As another option, the striker 14 may be arranged on the seat cushion 11, and the seat lock device 13 may be arranged on the floor surface of the vehicle body.

1. A seat lock device comprising:
a base arranged in one of a seat and a vehicle body, wherein the base includes a groove configured to receive a striker arranged on the other one of the seat and the vehicle body;
a case opposed to the base, wherein the case includes a groove configured to receive the striker;
a rotatable hook arranged between the base and the case, wherein the hook cooperates with at least the groove of the case to hold the striker in a locked state;
a rotatable pawl arranged between the base and the case, wherein the pawl is engaged with a peripheral surface of the hook to hold the hook in the locked state; and
a rotatable cam arranged between the base and the case, wherein the cam presses the hook held in the locked state in a lock direction, wherein
a portion of the hook and a portion of the pawl are overlapped with each ether in an axial direction of the hook and the pawl.

2. The seat lock device according to claim 1, wherein the cam presses the peripheral surface of the hook in the lock direction.

3. The seat lock device according to claim 1, wherein
a step having a height difference in a thickness-wise direction of the hook is arranged on an outer edge of the hook, wherein the step serves as the portion of the hook, and
the portion of the pawl is located within and overlapped with the step.

4. The seat lock device according to claim 1, wherein
a pressed portion that engages with the pawl and the cam projects from an outer edge of the hook, and
the portion of the hook overlapped with the pawl is a side surface of a distal part of the pressed portion that is farthest from an axis of the hook at a side opposite to the case.

5. The seat lock device according to claim 1, comprising:
a pawl spring arranged between the hook and the pawl, wherein the pawl spring inwardly rotates and biases the hook and the pawl toward each other; and
a snap including a bushing extending through the pawl, wherein the soap is configured to support a rod-shaped operation member operated to rotate the pawl against elastic force of the pawl spring in a direction that releases the pawl from a state engaged with the hook, wherein
a first end of the pawl spring is hooked to a lock hole of the hook, and a second end of the pawl spring is hooked to the bushing.
